(19) United States
(12) Patent Application Publication
(10) Pub. No.: US 2005/0048365 A1
(43) Pub. Date: Mar. 3, 2005

(54) Battery and manufacturing method thereof

(75) Inventors: Masaharu Miyahisa, Fujisawa-shi (JP); Hideki Kasahara, Naka-gun (JP); Yoshiyuki Tada, Fujisawa-shi (JP); Kazuyoshi Momoi, Matsue-shi (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/927,048

(22) Filed: Aug. 27, 2004

(30) Foreign Application Priority Data
Aug. 28, 2003 (JP) 2003-304050
May 21, 2004 (JP) 2004-151167

(51) Int. Cl. H01M 2/08; H01M 2/30; H01M 2/26; H01M 2/02

(52) U.S. Cl. 429/174; 429/94; 429/181; 429/161; 29/623.2; 29/623.4

(57) ABSTRACT

A battery which realizes high power output, cost reduction and increase in capacity. An enlarged port section is formed in an open end of a battery case. A ring-shaped support rack section is formed inside of the enlarged port section, and a ring-shaped insulating gasket is set on and supported by the support rack section. The battery has a collector of one pole, to which an end portion of an electrode plate of one pole protruding from an electrode plate group is connected. A ring and flange-shaped collar section, which is tiered with a step, is provided in the periphery of the collector, and the flange-shaped collar section is set on the bottom face of the insulating gasket. A port sealing member, in which a filter section and a cap-shaped terminal section are integrated with each other, is connected onto the collector. The enlarged port section is inwardly caulked, to fix the flange-shaped collar section of the collector and the periphery of the port sealing member, which are overlaid with each other, with the insulating gasket interposed therebetween.

The present disclosure relates to subject matter contained in priority Japanese Patent Application No. 2003-304050, filed on Aug. 28, 2003 and Japanese Patent Application No. 2004-151167, filed on May 21, 2004, the contents of which is herein expressly incorporated by reference in its entirety.

### BACKGROUND OF THE INVENTION

1. Field of the Invention

The present invention relates to a battery with the new structure of a collector to achieve increase in output and capacity at low cost, and a method for appropriately manufacturing the battery.

2. Description of the Related Art

In recent years, electrical equipment such as audio-video equipment, a personal computer, and mobile communication equipment has been rapidly made portable and cordless. As a driving power source of such electrical equipment, a battery with an aqueous solution such as a nickel-cadmium battery and a nickel metal hydride battery was conventionally used, but a battery with a non-aqueous electrolyte represented by a lithium rechargeable battery, which is rapidly charged up and has a high volume energy density and a high weight energy density, has recently become mainstream. The foregoing nickel-cadmium battery and the nickel metal hydride battery, on the other hand, tend to be specific to an application for a driving power source of a cordless power tool, an electric vehicle, and the like which need a high load characteristic, and hence a high-current discharge characteristic is required still further.

Conventionally, a battery having a structure as shown in FIG. 15 is generally used in an application for high-current discharge (refer to, for example, Japanese Patent Laid-Open Publication No. 2000-243433, FIG. 5). In this battery (hereinafter called a first conventional battery), an electrode plate group 50 is contained in a metal battery case 54 in the shape of a cylinder with a bottom. The electrode plate group 50 comprises a strip-shaped positive electrode plate 51 and a strip-shaped negative electrode plate 52 which are spirally wound with a separator 53 interposed between the positive and negative electrode plates 51 and 52. To structure a collector from the positive and negative electrode plates 51 and 52 in such a manner as to be suited for the high-current discharge, the electrode plate group 50 is so structured that one end portion 51a of the positive electrode plate 51 along the longitudinal direction of the positive electrode plate 51 protrudes upward of the electrode plate group 50 and one end portion 52a of the negative electrode plate 52 along the longitudinal direction of the negative electrode plate 52 protrudes downward of the electrode plate group 50. Approximately disk-shaped collectors 55 and 56 are welded to the end portions 51a and 52a at a plurality of points, respectively. An end portion of a positive electrode lead 57 is resistance welded to the positive electrode collector 55, and the other end portion of the positive electrode lead 57 is resistance welded to a filter section 59 of a port sealing member 58. A tongue 56a, which is formed in the negative electrode collector 56 by cutting and raising a part of the negative electrode collector 56, is resistance welded to the inner bottom face of the battery case 54.

The foregoing port sealing member 58 integrally comprises the filter section 59, a cap-shaped positive electrode terminal section 60, and a safety vent 61 held between the filter section 59 and the electrode terminal section 60. This port sealing member 58 is supported in a state of being mounted on a ring-shaped support section 54b, which is formed by a ring-shaped groove 54a provided in the outer periphery of the battery case 54 in such a manner as to protrude on the side of the inner surface of the battery case 54, with an insulating gasket 62 interposed between them. The periphery of the filter section 59 is pinched and fixed in a vertical direction by an inwardly caulked opening of the battery case 54 with the insulating gasket 62. Since the upper end periphery of the electrode plate group 50 makes contact with an insulating member 63, which is in contact with the bottom face of the ring-shaped support section 54b, the electrode plate group 50 is fixed inside the battery case 54.

As a second conventional battery used for an application for the high-current discharge, a battery in which the internal resistance of the battery is reduced by eliminating the positive electrode lead 57 is proposed (refer to, for example, Japanese Patent Laid-Open Publication No. 2001-256935). In the battery, a filter section of a port sealing member is directly connected to a positive electrode collector by welding without the medium of the positive electrode lead. Since the filter section of the port sealing member is made of a material with higher conductivity than a cap-shaped positive electrode terminal, when the cap-shaped positive electrode terminal is resistance welded to the filter section, a lot of welding current flows in a welding rack section between the filter section and the cap-shaped positive electrode terminal with reducing unavailable current flowing through the cap-shaped positive electrode terminal. Increase in the strength of welding results in decrease in electrical resistance in the welding rack section, that is, the internal resistance of the battery.

As a third conventional battery, there is a battery having a structure that the bottom face of a filter section of a port sealing member is directly connected to an end portion of a positive electrode plate protruding upward of an electrode plate group (refer to, for example, Japanese Patent Laid-Open Publication No. 2000-243433, FIG. 1). In this battery, both of the positive electrode lead and the positive electrode collector are eliminated to improve the high-current discharge characteristic, resistance to vibration, and resistance to impact.

As a fourth conventional battery, is known a battery having a structure that a positive electrode collector and a port sealing member are welded to a positive electrode lead member in a cylindrical shape with a hollow section (refer to, for example, Japanese Patent Laid-Open Publication No. 2001-143684). In this battery, the cylindrical positive electrode lead member is thicker than a general strip-shaped positive electrode lead to shorten a current path, and the positive electrode collector and the port sealing member are certainly welded to this positive electrode lead member, in order to improve the high-efficient discharge characteristic.

As a fifth conventional battery, a battery in which a positive electrode plate and a port sealing member are connected with the use of a collector lead member in the shape of integrating a positive electrode lead into a positive electrode collector is proposed (refer to, for example, Japanese Patent Laid-Open Publication No. 2002-231216). The foregoing collector lead member has a cut and raised section being a leg, which is formed as opposed to an approximately disk-shaped middle section. The top face of this cut and raised section is a flat surface having an area for a welding point. A bending guide section is provided in the cut and raised section, so that the bending guide section accelerates partial bending deformation in applying pressure for welding. Thus, contact with the welding point is increased due to increase in flexibility, and hence it is possible to reliably carry out the welding. Accordingly, this battery aims to prevent the occurrence of a short in the welding by evening force acting on the welding point, in order to carry out the welding with high reliability.

Furthermore, as a sixth conventional battery, there is a battery in which a positive electrode collector has a main section for carrying out collecting action, and a spring section formed by folding a part of the main section. The spring section biased in the outward direction of the battery makes contact with a port sealing member during normal conditions, in a state that an end portion of the spring section presses an insulating packing. Under abnormal conditions, the end portion of the spring section makes contact with a battery case to conduct electricity (refer to, for example, Japanese Patent Laid-Open Publication No. Hei 10-106532).

According to the first conventional battery, however, as shown in FIG. 15, the ring-shaped support section 54b having the function of pressing the electrode plate group 50 and supporting the port sealing member 58 is provided in the battery case 54, and the top end of the electrode plate group 50 and the port sealing member 58 are disposed separately at a large distance due to the existence of this ring-shaped support section 54b. Thus, the positive electrode lead 57 for connecting the positive electrode plate 51 of the electrode plate group 50 to the port sealing member 58 has to be formed long to a certain extent, and thin because the positive electrode lead 57 needs to be folded. This positive electrode lead 57 causes increase in the internal resistance of the battery, and hence this is a factor of impairing the high-current discharge characteristic. A welding section between the thin and long positive electrode lead 57 and the port sealing member 58 may short out, when strong vibration and impact applied to the battery moves the electrode plate group 50. This is a factor of reducing the resistance to vibration and the resistance to impact of the battery.

Furthermore, the foregoing battery needs the insulating member 63, in addition to the positive electrode lead 57, to prevent a short between the ring-shaped support member 54b of the battery case 54 and the positive electrode plate 51 of the electrode plate group 50. Thus, the number of parts increases, and complicated processes such as a process of welding the positive electrode lead 57 to the positive electrode plate 51 and the port sealing member 58 and a process of forming the ring-shaped groove 54a in the battery case 54 are necessary. Therefore, it is impossible to reduce cost. In the foregoing battery, unnecessary space occurs between the electrode plate group 50 and the port sealing member 58 by the existence of the ring-shaped support member 54b. Thus, since the volume of the electrode plate group 50 containable in the battery case 54 is reduced, it becomes difficult to increase the capacity of the battery.

In each of the second to sixth conventional batteries, the positive electrode lead is eliminated or substituted with another part to reduce the internal resistance of the battery, but the second to sixth conventional batteries have various problems described below. Namely, in the second conventional battery, after the filter section of the port sealing member is welded onto the collector, the insulating gasket is fitted onto the periphery of the filter section, and the ring-shaped groove has to be formed in the battery case in this state. Therefore, when the ring-shaped groove is formed in the battery case, distortion tends to occur in the filter section of the port sealing member.

In the third conventional battery, after the ring-shaped groove is formed in the battery case, the port sealing member is welded in a state that the insulating gasket is fitted onto the periphery of the port sealing member. Thus, it is necessary to carry out this welding operation with maintaining the state of compression of the insulating gasket. Since the unstable welding operation is required, the reliability of the welding is low. Especially, in this battery, the adoption of connection means by use of nickel brazing is proposed because this welding operation is extremely difficult. In the connection by use of the nickel brazing, however, temperature is increased to approximately 800 degrees centigrade, so that heat has adverse effect on the insulating gasket especially. Thus, there is a problem that the reliability of sealing is reduced, so that the battery is difficult to be in practical use.

In the fourth conventional battery, the positive electrode lead member having the special cylindrical shape with the hollow section is used instead of the existing positive electrode lead. This positive electrode lead member is disposed in such a position of filling a vent provided in the center of the port sealing member and a hollow section in the center of the electrode plate group, so that there is a possibility that the positive electrode lead member interferes with the operation of a safety mechanism, the impregnation of the electrode plate group with an electrolytic solution and the like.

When the positive electrode lead member is welded to the port sealing member, it is necessary to carry out the welding in a state that the port sealing member is in contact with the top of the cylindrical main section of the positive electrode lead member. Thus, after the electrolytic solution is injected into the battery case, one welding electrode is brought into contact with the port sealing member and the other welding electrode is brought into contact with the bottom face of the battery case, to carry out current-carrying welding, which feeds a welding current through the electrolytic solution. It is impossible to adopt connection means except for the current-carrying welding.

The fifth conventional battery has the approximately same defect as the foregoing fourth conventional battery. Namely, this battery uses the special shaped collector lead member, in which the cut and raised section, the flat surface for welding, and the bending guide section are integrated, instead of the existing positive electrode lead, so that it is impossible to reduce cost so much. The unnecessary space occurs between the electrode plate collector and the port sealing member by space for installing this collector lead member, and it is necessary to form the ring-shaped support member for supporting the port sealing member in the battery case, so that it becomes difficult to increase the capacity. When the collector lead member is welded to the port sealing member, it is necessary to carry out the welding in a state that the port sealing member is brought into contact with the welding surface of the collector lead member. Therefore, it is necessary to carry out the current-carrying welding, in which after an electrolytic solution is injected into the battery case, the one welding electrode is brought into contact with the port sealing member and the other welding electrode is brought into contact with the bottom face of the battery case to feed a welding current through the electrolytic solution. Connection means except for the current-carrying welding is not adoptable.

Furthermore, in the sixth conventional battery, the spring member is formed in the positive electrode collector by cutting and raising a part of the disk, or the separately formed spring member is joined to the top face of the disk member. If this positive electrode collector is welded to the electrode plate group, a negative electrode collector cannot be welded to the bottom face of the battery case. Thus, a troublesome operation of welding the positive electrode collector to the electrode plate group contained in the battery case after the negative electrode collector is welded to the bottom face of the battery case is required. Furthermore, an operation of welding the positive electrode collector to the port sealing member is also difficult.

### SUMMARY OF THE INVENTION

In view of the foregoing conventional problems, an object of the present invention is to provide a battery which has an easily manufactured structure while realizing high power output by eliminating parts such as a lead, cost reduction by reducing the number of parts and simplifying processes, and high capacity by increasing containment space for the electrode plate group in a battery case. Another object of the present invention is to provide a method for appropriately manufacturing this battery with high productivity.

To achieve the foregoing objects, a battery according to the present invention comprises a metal battery case in a shape of a cylinder with a bottom, an electrode plate group contained in the metal battery case, and a port sealing member. The electrode plate group includes a strip-shaped positive electrode plate and a strip-shaped negative electrode plate which are spirally wound with a separator interposed between the positive and negative electrode plates. The port sealing member tightly seals an opening in a top end of the battery case with an insulating gasket interposed therebetween. An enlarged port section is formed in the open end of the battery case above a top end of the electrode plate group, and a ring-shaped support rack section is provided inside of the enlarged port section. The battery has a collector of one pole. A flange-shaped collar section which is tiered with a step is formed in the periphery of the collector. The bottom face of the collector inside of the flange-shaped collar section is connected to an end portion of the electrode plate of one pole protruding from the electrode plate group. The periphery of the port sealing member, in which a filter section and a cap-shaped terminal section are integrated, is connected to the top face of the flange-shaped collar section. The flange-shaped collar section of the collector is set on a support bottom face of the insulating gasket held on the support rack section. The open end of the battery is inwardly caulked, and the periphery of the port sealing member is fixed in the enlarged port section with a reduced diameter with the insulating gasket interposed therebetween. In the present invention, “connection” includes electric connection means by just contact, in addition to mutual adhesion by welding means and the like.

According to the battery of the present invention, since the flange-shaped collar section of the collector, which is tiered with a step, is directly connected to the periphery of the port sealing member, a positive electrode lead provided in a conventional battery is eliminated. Therefore, the internal resistance of the battery is significantly reduced, and hence it is possible to obtain high power output. In addition to the elimination of the positive electrode lead, the battery case has the enlarged port section, and the battery has the insulating gasket which is set and held on the support rack section formed in the enlarged port section, so that a ring-shaped groove formed in the conventional battery becomes unnecessary. Accordingly, the volume of the electrode plate group can be increased by space which has occurred in a battery case of the conventional battery due to the existence of the positive electrode lead and the ring-shaped groove. Increase in the volume of the electrode plate group causes increase in the capacity of the battery. Also, in this battery, in addition to the elimination of the positive electrode lead, an upper section insulating part, which has been provided in the conventional battery, becomes unnecessary because the ring-shaped groove is not formed. Thus, since the number of parts is reduced, and attachment processes of these unnecessary parts and a forming process of the ring-shaped groove are eliminated, it is possible to significantly reduce cost. Also the port sealing member and/or the collector of the one pole are horizontally clamped by the enlarged port section with the reduced diameter in the battery case with the insulating gasket interposed therebetween. Therefore, the resistance to vibration and the resistance to impact of the battery are significantly improved.

Another battery according to the present invention comprises a metal battery case in a shape of a cylinder with a bottom, an electrode plate group contained in the metal battery case, and a port sealing member. The electrode plate group includes a strip-shaped positive electrode plate and a strip-shaped negative electrode plate which are spirally wound with a separator interposed between the positive and negative electrode plates. The port sealing member tightly seals an opening in a top end of the battery case with an insulating gasket interposed therebetween. An enlarged port section is formed in the open end of the battery case above a top end of the electrode plate group, and a ring-shaped support rack section is provided inside the enlarged port section. The battery has a collector of one pole, in the periphery of which a welding rack section tiered with a step is formed. The bottom face of the collector inside of the welding rack section is connected to an end portion of the electrode plate of one pole protruding from the electrode plate group. The periphery of the port sealing member, in which a filter section and a cap-shaped terminal section are integrated, is set on a support bottom face of the insulating gasket held on the support rack section. Also, the welding rack section of the collector of the one pole is connected to a part of the port sealing member inside of the periphery thereof, and the open end is inwardly caulked. Also, the periphery of the port sealing member is fixed in the enlarged port section with a reduced diameter with the insulating gasket interposed therebetween.

In the foregoing battery according to the present invention, since the collector of one pole has the smaller external diameter than the filter portion of the port sealing member, and has the welding rack section which is tiered with the step in the periphery thereof, it is possible to provide as many connecting sections as possible even if the flange-shaped collar section is omitted in the collector of one pole. Also, in this battery, only the periphery of the filter section of the port sealing member is held on the support rack section of the battery case with the insulating gasket interposed therebetween. Therefore, the internal resistance of the battery is significantly reduced due to the elimination of a positive electrode lead, and hence it is possible to obtain high power output, even if an existing gasket is used as the insulating gasket.

A manufacturing method of a battery according to the present invention comprises the steps of: connecting a bottom face of a positive electrode collector inside of a flange-shaped collar portion, which is formed in the periphery of the positive electrode collector while being tiered with a step, to an end portion of a positive electrode plate of an electrode plate group, and connecting a negative electrode collector to an end portion of a negative electrode plate of the electrode plate group; attaching an insulating gasket onto the positive electrode collector before or after being connected to the end portion of the positive electrode plate; inserting the electrode plate group into a battery case to support the insulating gasket on a ring-shaped support rack section, which is formed inside of an enlarged port section formed above a top end of the electrode plate group in the battery case; connecting the negative electrode collector to the bottom face of the battery case by welding; injecting an electrolytic solution into the battery case through an opening formed in the positive electrode collector; laminating and connecting a periphery of a port sealing member on a top face of the flange-shaped collar section of the positive electrode collector; and inwardly caulking an open end of the battery and reducing a diameter of the enlarged port section to fix the periphery of the port sealing member and/or the flange-shaped collar section of the positive electrode collector with the insulating gasket interposed therebetween.

In the foregoing manufacturing method of the battery according to the present invention, it is possible to weld the flange-shaped collar portion of the collector to the periphery of the port sealing member, which is laminated on the flange-shaped collar portion of the collector, in a state that the collector is stably supported on the support rack section of the battery case with the insulating gasket interposed therebetween. Also, after the electrolytic solution is injected, the previously integrated port sealing member can be welded to the positive electrode collector by feeding a welding current through the electrolytic solution. Therefore, it is possible to manufacture the battery with high productivity.

Furthermore, another manufacturing method of a battery according to the present invention comprises the steps of: connecting a bottom face of a positive electrode collector inside of a flange-shaped collar portion, which is formed in a periphery of the positive electrode collector, to an end portion of a positive electrode plate of an electrode plate group, and connecting a negative electrode collector to an end portion of a negative electrode plate of the electrode plate group; laminating and welding a periphery of a filter section of a port sealing member to a top face of the flange-shaped collar portion of the positive electrode collector for connection; attaching an insulating gasket onto the periphery of each of the positive electrode collector and the filter section from above; inserting the electrode plate group into a battery case to support the insulating gasket on a ring-shaped support rack section, which is formed inside of an enlarged port section formed above a top end of the electrode plate group in the battery case; connecting the negative electrode collector to the bottom face of the battery case by welding; injecting an electrolytic solution into the battery case through a vent of the filter section and an opening of the positive electrode collector; connecting the filter section and a cap-shaped positive electrode terminal to each other by welding in a state that the positive electrode terminal is laminated on the filter section with a safety vent interposed therebetween to assemble the port sealing member; and inwardly caulking an open end of the battery case, and reducing a diameter of the enlarged port section to fix the periphery of the filter section and/or the flange-shaped collar section of the positive electrode collector with the insulating gasket interposed therebetween.

In the foregoing manufacturing method of the battery according to the present invention, it is possible to easily weld the flange-shaped collar section of the positive electrode collector, which is welded to the electrode plate group, to the periphery of the filter section of the port sealing member in a state without attaching the insulating gasket by use of resistance welding, directly without the medium of the electrolytic solution. Therefore, it is possible to firmly connect the positive electrode collector to the filter section with high welding quality by precisely carrying out welding. Also the insulating gasket is attached to the flange-shaped collar section of the positive electrode collector and the periphery of the filter section of the port sealing member, which are secured to each other by this welding, from above. The open end of the battery case is caulked, and the diameter of the enlarged port section is reduced to firmly fix the periphery of the filter section and/or the flange-shaped collar section of the positive electrode collector with the insulating gasket interposed therebetween. In this state, the electrolytic solution is injected through the vent of the filter section and the opening of the positive electrode collector, and then the safety vent and the cap-shaped positive electrode terminal are attached to the filter section to assemble the port sealing member. Accordingly, assembly processes are efficiently carried out due to improvement in the workability of every assembly process. Therefore, it is possible to improve the productivity of the battery.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1 is a longitudinal sectional view of a battery according to a first embodiment of the present invention;

FIGS. 2A and 2B show a positive electrode collector in the battery, FIG. 2A is a plan view and FIG. 2B is a sectional view taken along the line IIB-IIB in FIG. 2A;

FIG. 3 is an enlarged sectional view showing a part of an insulating gasket in the battery;

FIGS. 4A and 4B are sectional views successively showing the first half of a manufacturing process of the battery;

FIGS. 5A to SC are sectional views successively showing the latter half of the manufacturing process of the battery;

FIGS. 6A and 6B are sectional views showing the first half of a manufacturing process of a battery according to a second embodiment of the present invention;

FIGS. 7A to 7C are sectional views showing the middle of the manufacturing process of the battery;

FIG. 8A and 8B are sectional views showing the latter half of the manufacturing process of the battery;

FIG. 9 is a perspective view of a negative electrode collector in the battery in a state of being turned upside down;

FIG. 10 is a longitudinal sectional view of a battery according to a third embodiment of the present invention;

FIGS. 11A to 11D are sectional views successively showing the first half of a manufacturing process of the battery;

FIGS. 12A to 12C are sectional views successively showing the latter half of the manufacturing process of the battery;

FIG. 13 is a longitudinal sectional view of a battery according to a fourth embodiment of the present invention;

FIGS. 14A to 14C show a positive electrode collector in the battery, FIG. 14A is a plan view, FIG. 14B is a sectional view taken along the line XIVB-XIVB in FIG. 14A, and FIG. 14C is a sectional view taken along the line XIVC-XIVC in FIG. 14A; and

FIG. 15 is a longitudinal sectional view of a conventional battery.

### DETAILED DESCRIPTION OF THE PREFERRED EMBODIMENTS

Embodiments of the present invention will be hereinafter described with reference to the accompanying drawings. Each embodiment described below is just an example embodying the present invention, and does not limit the technical scope of the present invention.

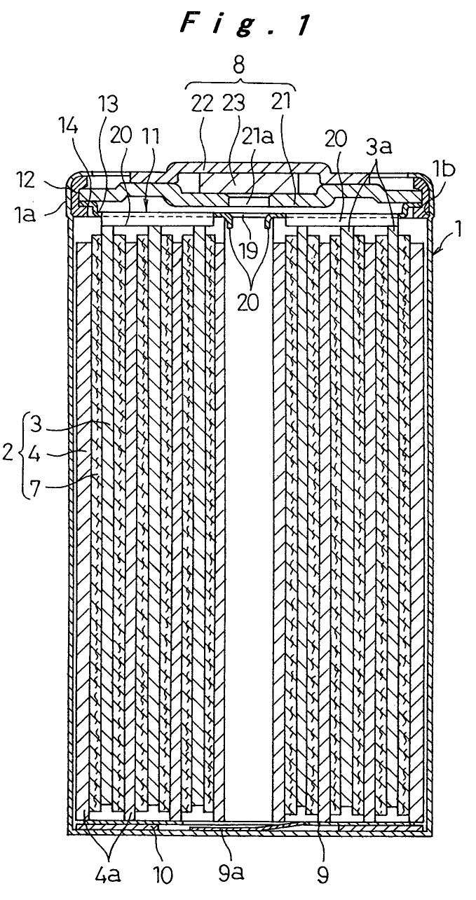

FIG. 1 is a longitudinal sectional view showing a battery according to a first embodiment of the present invention. This battery comprises a metal battery case 1 in the shape of a cylinder with a bottom, an electrode plate group 2, and a port sealing member 8. The electrode plate group 2 includes a strip-shaped positive electrode plate 3 and a strip-shaped negative electrode plate 4 which are spirally wound with a separator 7 interposed between the positive and negative electrode plates 3 and 4. The port sealing member 8 tightly seals an opening of the battery case 1 with an insulating gasket 12. The electrode plate group 2 contained in the battery case 1 composes a power generating component together with an electrolytic solution (not illustrated). In this embodiment, an SC-sized battery is manufactured, and various properties thereof are measured as described later.

An end portion 3a of the foregoing positive electrode plate 3 along the longitudinal direction of the strip-shaped positive electrode plate 3 protrudes upward from the electrode plate group 2, and an end portion 4a of the foregoing negative electrode plate 4 along the longitudinal direction of the strip-shaped negative electrode plate 4 protrudes downward from the electrode plate group 2. A disk-shaped negative electrode collector 9 is connected to the end portion 4a of the negative electrode plate 4 by welding, and an elastic conductive body 10 made of a foamed metal ring is inserted between the negative electrode collector 9 and the bottom face of the battery case 1. A cut is made in the middle of the negative electrode collector 9, and a tongue-shaped negative electrode collector piece 9a formed by downwardly raising the cut is connected to the bottom face of the battery case 1 by resistance welding. A positive electrode collector 11, on the other hand, is connected to the end portion 3a of the positive electrode plate 3 by resistance welding.

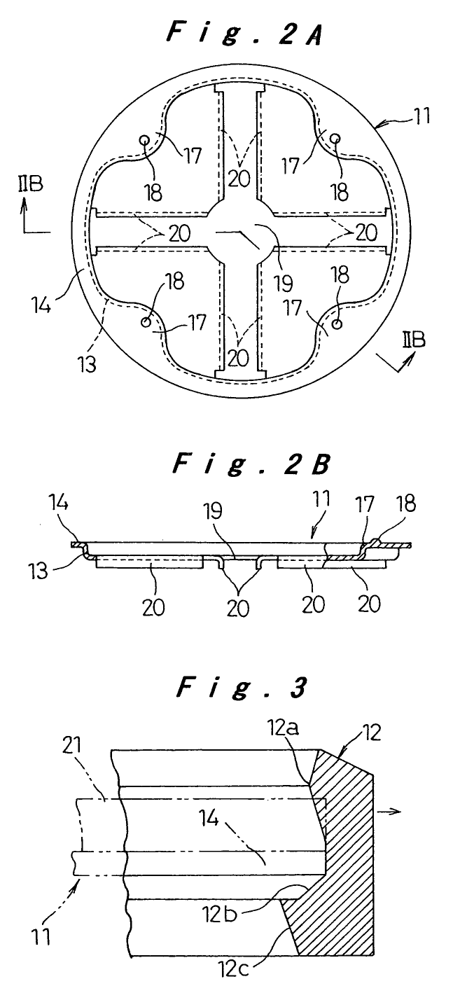

The periphery (a flange-shaped collar section 14 described later) of the foregoing positive electrode collector 11 is supported while being set on a support rack section 1b in an enlarged port section 1a of the battery case 1 with the insulating gasket 12 interposed therebetween. This structure will be hereinafter described in detail. FIG. 2A is a plan view of the foregoing positive electrode collector 11, and FIG. 2B is a sectional view taken along the line IIB-IIB in FIG. 2A. This positive electrode collector 11 is slightly smaller than the internal diameter of the enlarged port section la of the battery case 1. The positive electrode collector 11 has a disk-like outside shape the external diameter of which is the approximately same as the external diameter of a filter section 21 (described later) of the port sealing member 8. The flange-shaped collar section 14, which is tiered with a step 13, is provided in the periphery of the positive electrode collector 11. In this flange-shaped collar section 14, welding rack sections 17 which are inwardly protruding from four points at regular intervals of 90 degrees while they maintain coplanarity are continuously provided. In this embodiment, each welding rack section 17 has a projection 18 protruding upwardly.

Furthermore, the foregoing positive electrode collector 11 is perforated with an opening 19 in a recessed portion inward the flange-shaped collar section 14. The opening 19 has the shape of a cross viewed from above, and each end portion extends toward the points between the welding rack sections 17. Burring projecting pieces 20 which are perpendicularly bent from this opening 19 in a downward direction are formed integrally with the collector 11. This positive electrode collector 11 is connected to the positive electrode plate 3 by resistance welding in a state that a part of the burring projecting piece 20 is engaged in a tip of the end portion 3a while each of the eight burring projecting pieces 20 in total intersects with the end portion 3a of the positive electrode plate 3.

The diameter of the foregoing enlarged port section 1a of the battery case 1 is slightly larger than that of the main body section, in which the electrode plate group 2 is contained. The support rack section 1b is formed between the enlarged port section 1a and the main body section. This enlarged port section 1a is formed in a position slightly above the top end of the electrode plate group 2 contained in the main body section of the battery case 1.

The foregoing insulating gasket 12 is molded of a synthetic resin, and the external diameter of the insulating gasket 12 is the approximately same as the internal diameter of the enlarged port section 1a of the foregoing battery case 1. As shown in FIG. 3 which is an enlarged sectional view of a part of the insulating gasket 12, a latching projection part 12a is formed in the vicinity of the top end of the opening. The latching projection part 12a projects inwardly, and the internal diameter thereof is slightly smaller than the external diameter of the filter section 21 of the port sealing member 8 described later. The insulating gasket 12 has a support bottom face 12b which is in the shape of a ring inwardly protruding from a bottom end, and a tapered surface 12c in which an end face of this support bottom face 12b is enlarged downward. The support bottom face 12b, on which the flange-shaped collar section 14 of the positive electrode collector 11 is put, supports the positive electrode collector 11. Therefore, the insulating gasket 12 is approximately in the shape of a letter L in cross section.

The foregoing port sealing member 8 comprises the filter section 21, a cap-shaped positive electrode terminal 22, and a rubber safety vent 23. The filter section 21 has a vent 21a for discharging gas occurring inside the battery. The cap-shaped positive electrode terminal 22 is overlaid and fixed on the filter section 21. The safety vent 23 sandwiched and fixed between the filter section 21 and the cap-shaped positive electrode terminal 22 clogs the vent 21a. The external diameter of the foregoing filter section 21 is the approximately same as the external diameter of the positive electrode collector 11. The filter section 21 is connected to the positive electrode collector 11 by welding at four points corresponding to the four welding rack sections 17 of the positive electrode collector 11, while the periphery of the filter section 21 is overlaid on the flange-shaped collar section 14 of the positive electrode collector 11. An overlap section between the periphery of the filter section 21 and the flange-shaped collar section 14 of the positive electrode collector 11 is inwardly caulked in the battery case 1, and the enlarged port section 1a with the reduced diameter firmly fixes the overlap section in a horizontal clamping state with the insulating gasket 12 interposed therebetween.

In the foregoing battery, the welding rack sections 17 of the positive electrode collector 11 are connected to the filter section 21 through the projections 18 by current-carrying welding, in a state that the periphery of the filter section 21 of the port sealing member 8 is overlaid on the flange-shaped collar section 14, which is provided in the positive electrode collector 11 so as to be tiered upward with a step, in order to electrically connect to each other. Thus, a positive electrode lead (for example, a positive electrode lead 57 in FIG. 15) provided in a conventional battery is eliminated. Therefore, voltage drop due to the positive electrode lead is eliminated in this battery. Also, the number of passing collection joints is reduced and collection distance is shortened by the elimination of the positive electrode lead, so that the internal resistance of the battery is significantly reduced. Therefore, it is possible to obtain high power output.

In the foregoing battery, the battery case 1 has the enlarged port section 1a, and the insulating gasket 12, which has such a shape as to be supported with being set on the support rack section 1b formed inside of the bottom end of the enlarged port section 1a, is provided, in addition to the elimination of the positive electrode lead as described above. Thus, a ring-shaped groove (for example, a ring-shaped groove 54a in FIG. 15) formed in a conventional battery becomes unnecessary. Accordingly, it is possible to increase the height of the electrode plate group 2 to increase the volume thereof by eliminating unnecessary space occurring in a battery case of the conventional battery due to the existence of the ring-shaped groove and the positive electrode lead. Therefore, increase in the volume of the electrode plate group 2 brings about increase in the capacity of the battery.

Furthermore, in the foregoing battery, in addition to the elimination of the positive electrode lead as described above, an insulating member (for example, an insulating member 63 in FIG. 15) provided in the conventional battery becomes unnecessary because the ring-shaped groove is not formed. Accordingly, the number of parts is reduced, and an attachment process for this unnecessary part and a forming process of the ring-shaped groove are eliminated, and hence it is possible to accomplish significant cost reduction.

In the conventional battery having the ring-shaped groove, pressure is applied only from above in the axial direction of the battery case, because an opening of the battery case is inwardly caulked and the ring-shaped groove is deformed into a shape shown in FIG. 15. Thus, an electrode plate group 50 is fixed by the insulating member 63. In the foregoing battery according to the present invention, the positive electrode collector 11 and the port sealing member 8 are horizontally clamped by reducing the diameter of the enlarged port section 1a provided in the battery case 1 with the insulating gasket 12 interposed therebetween, in order to firmly fix the positive electrode collector 11 and the port sealing member 8. Since the firmly fixed port sealing member 8 and the positive electrode collector 11 fix the electrode plate group 2, it is possible to significantly improve resistance to vibration and resistance to impact even if the insulating member of the conventional battery is eliminated.

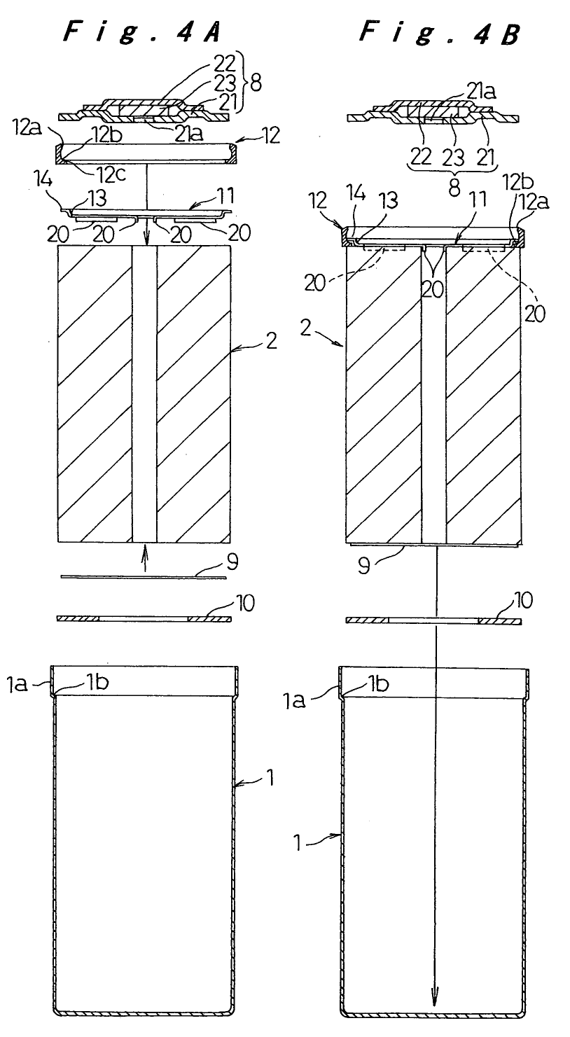

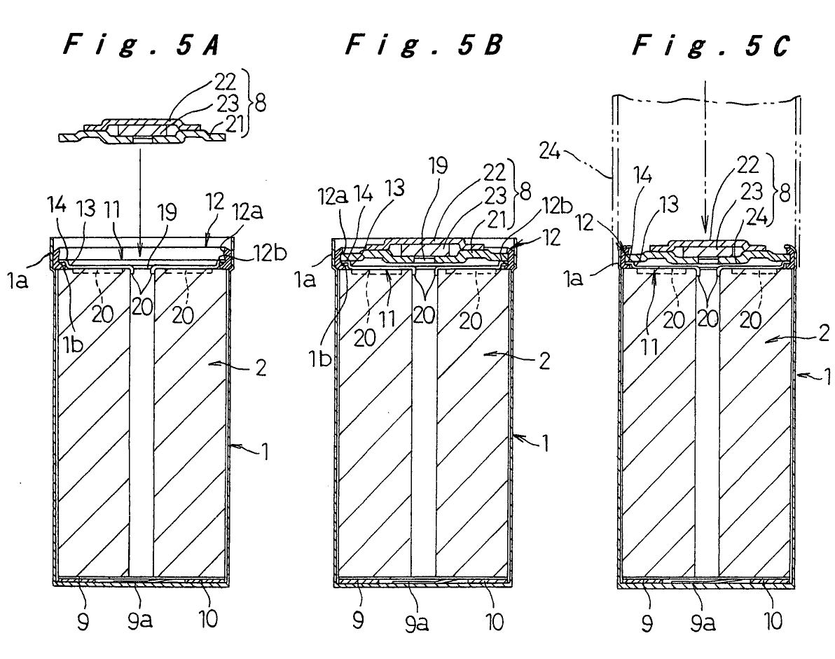

Then, the manufacturing process of the foregoing battery will be described with reference to FIGS. 4A to 5C. FIG. 4A shows the relative disposition of each part corresponding to an assembly procedure. To assemble the port sealing member 8, the filter section 21, the cap-shaped positive electrode terminal 22, and the safety vent 23 are integrated in advance in predetermined positions. In a first step, as shown by arrows in FIG. 4A, the negative electrode collector 9 is opposed to the end portion 4a of the negative electrode plate 4 in the electrode plate group 2 shown in FIG. 1 to carry out the resistance welding. Also, the positive electrode collector 11 is opposed to the end portion 3a of the positive electrode plate 3 in the electrode plate group 2 shown in FIG. 1 to carry out the resistance welding.

The resistance welding of the foregoing negative electrode collector 9 and the positive electrode collector 11 is carried out with the use of an exclusive welding jig (not illustrated). Since the eight burring projecting pieces 20 in total are formed in the shape of the cross in the positive electrode collector 11, when the positive electrode collector 11 is welded to the end portion 3a of the positive electrode plate 3, each of these burring projecting pieces 20 is relatively opposed to the end portion 3a of the positive electrode plate 3 in an approximately orthogonal manner and a pair of welding electrodes, which is brought into contact with a flat plate section at two points across the opening 19, applies pressure to carry out the resistance welding. The existence of the opening 19 reduces unavailable current flowing through the surface of the positive electrode collector 11 between the pair of welding electrodes, and increases a welding current flowing through the intersections between the burring projecting pieces 20 and the end portion 3a of the positive electrode plate 3. Each burring projecting piece 20 is melted while being engaged in the end portion 3a of the positive electrode plate 3, so that the burring projecting pieces 20 are firmly welded to the end portion 3a of the positive electrode plate 3. Accordingly, contact resistance in the welding sections between the burring projecting pieces 20 and the end portion 3a of the positive electrode plate 3 is reduced, and hence it is possible to reduce the internal resistance of the battery. Since the resistance welding is carried out in a state that the positive electrode collector 11 is not attached to the insulating gasket 12, it is possible to easily carry out welding operations.

Next, the insulating gasket 12 is attached onto the flange-shaped collar section 14 of the positive electrode collector 11 which is welded to the positive electrode plate 3. In this attaching operation, the insulating gasket 12 is pressed against the positive electrode collector 11 from above, so that the insulating gasket 12 is elastically deformed so as to enlarge its diameter, while the peripheral end face of the flange-shaped collar section 14 of the positive electrode collector 11 slides on the tapered surface 12c of the insulating gasket 12. The flange-shaped collar section 14 of the positive electrode collector 11 is being inserted into the internal space of the insulating gasket 12. When the bottom face of the insulating gasket 12 makes contact with the top end face of the electrode plate group 2 as shown in FIG. 4B, the flange-shaped collar section 14 of the positive electrode collector 11 is fitted in the top end of the inclined support bottom face 12b of the insulating gasket 12, as shown by chain double-dashed lines in FIG. 3. In this manner, as shown in FIG. 4B, the negative electrode collector 9, the positive electrode collector 11, and the insulating gasket 12 are attached to the electrode plate group 2 in advance, prior to insertion into the battery case 1.

Then, as shown by an arrow in FIG. 4B, the elastic conductive body 10 is inserted into the bottom of the battery case 1. After that, the electrode plate group 2, to which the negative electrode collector 9, the insulating gasket 12, and the positive electrode collector 11 are attached in advance as described above, is inserted into the battery case 1 to bring them into a state of FIG. 5A. Then, long and narrow welding electrodes are inserted into an opening in the center of the electrode plate group 2 from above, to connect the foregoing negative electrode collector piece 9a to the bottom face of the battery case 1 by the resistance welding in a state that the negative electrode collector piece 9a of the negative electrode collector 9 deformed downward in the shape of the tongue is pressed against the bottom face of the battery case 1. After that, a predetermined amount of the electrolytic solution is injected into the battery case 1 through the cross-shaped opening 19 of the positive electrode collector 11.

Furthermore, the port sealing member 8 assembled in advance is inserted into the enlarged port section 1a of the battery case 1 as shown by an arrow in FIG. 5A, and the periphery of the filter section 21 is overlaid on the flange-shaped collar section 14 of the positive electrode collector 11 in the state of being fitted into the insulating gasket 12 as shown in FIG. 5B. At this time, as shown by chain double-dashed lines in FIG. 3, the filter section 21 of the port sealing member 8 is inserted into the insulating gasket 12 while spreading the latching projection part 12a of the insulating gasket 12 outside as shown by an arrow, and the filter section 21 is overlaid on the flange-shaped collar section 14 of the positive electrode collector 11, which is fitted in the upper end of the support bottom face 12b of the insulating gasket 12. When the filter section 21 is completely fitted into the insulating gasket 12, the latching projection part 12a of the insulating gasket 12 holds the periphery of the filter section 21 so as not to slip out with the use of resilience of itself. Therefore, the port sealing member 8 is maintained in the state of being overlaid on the positive electrode collector 11, that is, in a state that the periphery of the filter section 21 certainly makes contact with the projections 18 formed each of the four welding rack sections 17 of the positive electrode collector 11.

In the foregoing state, a pair of welding electrodes (not illustrated) are brought into contact with a part of the filter section 21 of the port sealing member 8 corresponding to the projection 18 of the collector 11 and the battery case 1, to connect the filter section 21 to the positive electrode collector 11 by the current-carrying welding, in which the welding current flows through the electrolytic solution in the battery case 1. When the welding is carried out, since the flange-shaped collar section 14 of the positive electrode collector 11 is certainly supported by the support rack section 1b of the battery case 1 through the insulating gasket 12, and the filter section 21 of the port sealing member 8 is certainly held with the insulating gasket 12 in an overlaid state to the positive electrode collector 11, it is possible to easily carry out the current-carrying welding under an extremely stable condition. The outside shape of the positive electrode collector 11 is the approximately same as the outside shape of the port sealing member 8. Since the welding rack sections 17 inwardly extending from a plurality of points of the flange-shaped collar section 14 of the positive electrode collector 11 are welded to the periphery of the filter section 21 of the port sealing member 8, it is possible to smoothly carry out the foregoing current-carrying welding without disturbance by the insulating gasket 12.

When the positive electrode collector 11 is connected to the filter section 21 of the port sealing member 8 by the current-carrying welding through the projections 18, as described above, a value of resistance in connection portions is reduced to approximately 3.5 mΩ, though a value of resistance in the SC-sized battery in which the positive electrode collector 11 just makes contact with the filter section 21 of the port sealing member 8 is approximately 10 mΩ. Therefore, it is possible to further increase the output. Precise formation of relatively large nuggets by the current-carrying welding through the projections 18 results in reduction in the value of resistance.

Lastly, as shown in FIG. 5C, after the open end of the battery case 1 is inwardly caulked, the battery case 1 is pressed and inserted into a cylinder 24 for a diameter reducing processing, the internal diameter of which is slightly smaller than the external diameter of the enlarged port section 1a of the battery case 1, from the bottom of the battery case 1 in order to reduce the diameter of the enlarged port section 1a of the battery case 1. When the battery case 1 is caulked, the caulked open end of the battery case 1 slightly presses down the electrode plate group 2 through the port sealing member 8 and the positive electrode collector 11. Therefore, the electrode plate group 2 is fixed in the battery case 1 so as not to move in the axial direction of the battery case 1. At this time, the insulating gasket 12 shown in FIG. 3 is deformed by receiving pressure from above from the caulked open end of the battery case 1, and the support bottom face 12b is pressed against the bottom face of the flange-shaped collar section 14 of the positive electrode collector 11. The elastic conductive body 10, on the other hand, is plastically deformed by receiving a pressing force from the electrode plate group 2, so that variations in the height of end portions 3a and 4a of the positive electrode plate 3 and the negative electrode plate 4 in the electrode plate group 2 are absorbed.

A negative electrode collector 27 with elastic resilience in a shape as shown in FIG. 9 may be used instead of this elastic conductive body 10. FIG. 9 is a perspective view of the negative electrode collector 27 in a state of being turned upside down. The external diameter of this disk-shaped negative electrode collector 27 is smaller than the external diameter of the electrode plate group 2. The negative electrode collector 27 is a disc spring which has an elastic connecting section 27a downwardly projecting in the middle of the negative electrode collector 27. The elastic connecting section 27a is elastically supported by four projecting legs 27b which are formed at regular intervals of 90 degrees.

Since the diameter of the enlarged port section 1a of the battery case 1 is reduced, the filter section 21 of the port sealing member 8 and the positive electrode collector 11 are horizontally clamped with the insulating gasket 12 interposed therebetween, so that the port sealing member 8 is certainly fixed by extremely firm holding structure. Also, the electrode plate group 2 is fixed while being slightly compressed by, for example, approximately 0.2 mm in the axial direction of the battery case 1, and hence the resistance to vibration and the resistance to impact of the battery are significantly improved. Furthermore, the end portion 4a of the negative electrode plate 4 of the electrode plate group 2 is connected to the bottom face of the battery case 1. In addition to that, when the elastic conductive body 10 made of the ring-shaped foamed metal is deformed by compression, the elastic conductive body 10 electrically connects the end portion 4a of the negative electrode plate 4 to the bottom face of the battery case 1 with reliability through the negative electrode collector 9. Therefore, the effect of current collection is further increased.

In the foregoing embodiment, the welding rack section 17 of the positive electrode collector 11 is provided with the projection 18, and the positive electrode collector 11 and the filter section 21 of the port sealing member 8 are connected to each other by the projection current-carrying welding. In this battery, however, it is possible to keep a state that the periphery of the filter section 21 is precisely overlaid on the welding rack sections 17 of the positive electrode collector 11 by use of the insulating gasket 12 and the support rack section 1b of the battery case 1. Therefore, the welding rack sections 17 of the positive electrode collector 11 are connected to the periphery of the filter section 21 by laser welding. In carrying out the laser welding, a value of the internal resistance of the battery becomes approximately 4 mΩ, so that it is possible to obtain a favorable result which is the approximately same as the case of the foregoing current-carrying welding through the projections 18. Furthermore, there is no harm in omitting a welding process, because the flange-shaped collar section 14 of the positive electrode collector 11 and the periphery of the filter section 21 are held in an electrical connection state with reliability. In this case, however, the internal resistance is increased to approximately 10 mΩ.

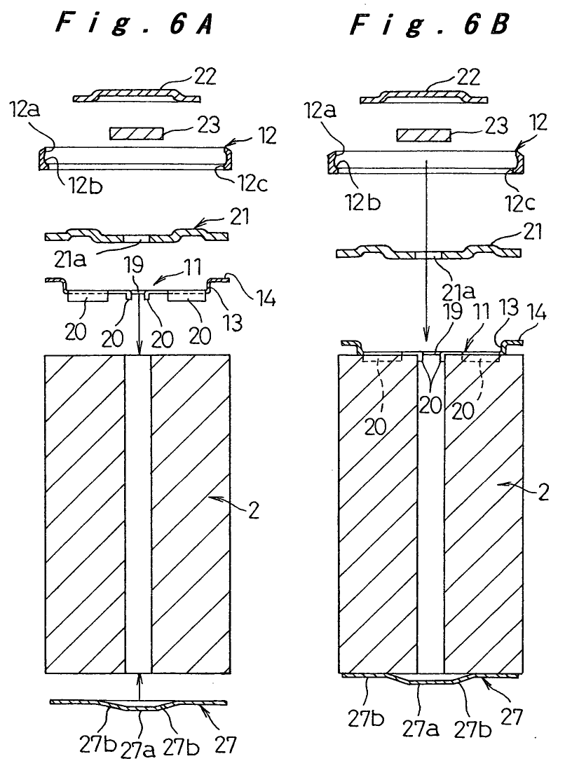

Then, a battery according to a second embodiment of the present invention will be described. The battery according to this embodiment has the approximately same structure as the battery according to the first embodiment, but a manufacturing method thereof is quite different. The manufacturing method of this battery will be hereinafter described on the basis of FIGS. 6A to 8B which successively show the manufacturing method. In FIGS. 6A to 8B, the same numbers as FIGS. 4A to 5C refer to identical or similar components, and duplicate description will be omitted.

FIG. 6A shows the relative disposition of each part corresponding to an assembly procedure. In contrast to the battery according to the first embodiment, a filter section 21, a cap-shaped positive electrode terminal 22, and a safety vent 23 are assembled into a port sealing member 8 during the process of manufacturing the battery. In the first process as shown by arrows in FIG. 6A, a negative electrode collector 27 exclusive of an elastic connecting section 27a and four projecting legs 27b is brought into contact with an end portion 4a of a negative electrode plate 4 shown in FIG. 1 in an electrode plate group 2 to carry out resistance welding. Also, a positive electrode collector 11 is brought into contact with an end portion 3a of a positive electrode plate 3 shown in FIG. 1 in the electrode plate group 2 to carry out resistance welding.

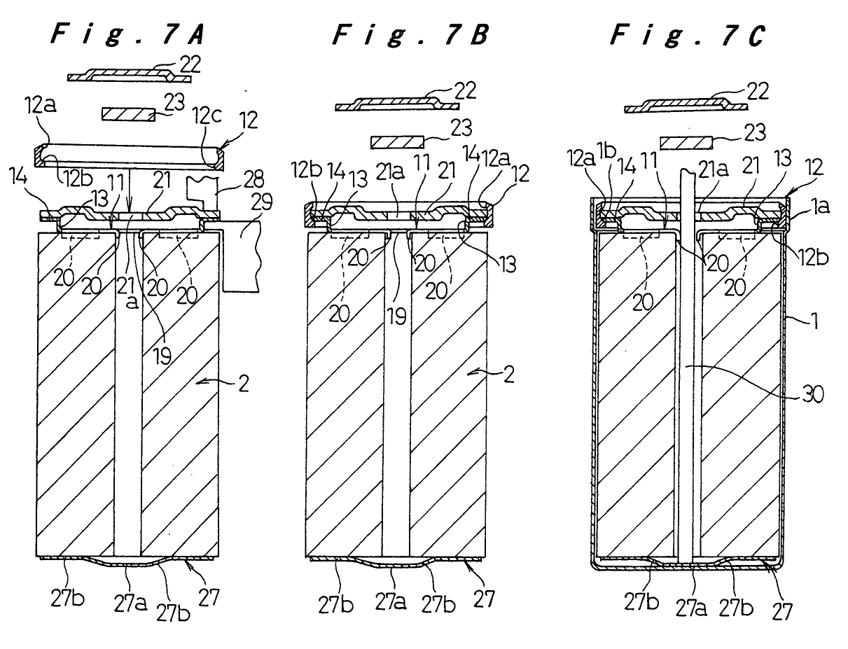

Then, as shown by an arrow in FIG. 6B, the periphery of the filter section 21 of the port sealing member 8 is overlaid on a flange-shaped collar section 14 of the positive electrode collector 11 to bring them into a state of FIG. 7A. Then, the flange-shaped collar section 14 of the positive electrode collector 11 is welded to the periphery of the filter section 21 by resistance welding with the use of a pair of welding electrodes 28 and 29. In this embodiment, as described above, it is possible to easily weld the flange-shaped collar section 14 of the positive electrode collector 11, which is welded to the electrode plate group 2, to the periphery of the filter section 21 of the port sealing member 8 without attaching an insulating gasket 12. Also the flange-shaped collar section 14 is directly welded to the periphery of the filter section 21 by the resistance welding without the mediation of an electrolytic solution. Therefore, it is possible to realize firm connection with high welding quality by precisely carrying out the welding. In this embodiment, since the flange-shaped collar section 14 of the positive electrode collector 11 is directly welded to the periphery of the filter section 21 of the port sealing member 8 by the resistance welding, the positive electrode collector 11 may be provided with no projection. As a matter of course, the positive electrode collector 11 may be provided with the projection also in this embodiment, and the flange-shaped collar section 14 may be welded to the periphery of the filter section 21 by projection welding.

Next, as shown by an arrow in FIG. 7A, the insulating gasket 12 is attached onto the flange-shaped collar section 14 of the positive electrode collector 11 and the periphery of the filter section 12 which are connected to each other. In this attachment operation, the insulating gasket 12 is pressed against the periphery of the filter section 21 from above, so that the insulating gasket 12 is elastically deformed so as to enlarge its diameter, while the peripheral end face of the filter section 21 slides on a tapered surface 12c of the insulating gasket 12. The filter section 21 and the positive electrode collector 11 are being inserted into the internal space of the insulating gasket 12. When the flange-shaped collar section 14 of the positive electrode collector 11 is opposed to the top end of an inclined support bottom face 12b of the gasket 12, as shown in FIG. 7B, an inserting operation of the insulating gasket 12 is stopped.

Thus, the insulating gasket 12 is so deformed that the filter section 21 of the port sealing member 8 outward spreads the latching projection part 12a of itself, and hence the insulating gasket 12 is crimped onto the periphery of the filter section 21 by the resilience of the deformed latching projection part 12a. In this manner, as show in FIG. 7B, the negative electrode collector 9, the positive electrode collector 11, the filter section 21, and the insulating gasket 12 are previously attached to the electrode plate group 2 in advance of being inserted into a battery case 1.

Then, the electrode plate group 2, to which the negative electrode collector 9, the positive electrode collector 11, the filter section 21, and the insulating gasket 12 are previously attached as described above, is inserted into the battery case 1 to bring them into a state of FIG. 7C. At this time, the bottom face of the insulating gasket 12 is set on a support rack section 1b of the battery case 1. The support rack section 1b holds the positive electrode collector 11 and the filter section 21 with the insulating gasket 12 interposed therebetween, and an elastic connecting section 27a of a negative electrode collector 27 elastically makes contact with the bottom face of the battery case 1. In this state, long and narrow welding electrodes 30, which are inserted into the opening in the center of the electrode plate group 2 from above, are brought into contact with the elastic connecting section 27a of the negative electrode collector 27, to connect the negative electrode collector 27 to the bottom face of the battery case 1. Therefore, since this battery uses the negative electrode collector 27 in the shape of the disc spring, the battery has the advantage that current does not intensively flow into a certain point, as in the case of using the negative electrode collector with a tab-shaped tongue.

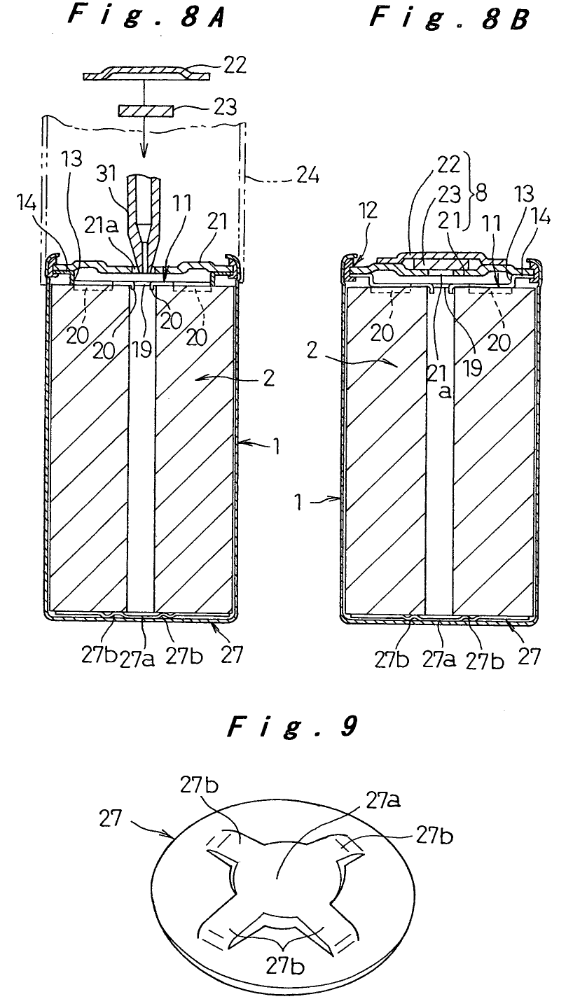

Next, as shown in FIG. 8A, after an open end of the battery case 1 is inwardly caulked, the battery case 1 is pressed and inserted into a cylinder 24 for the diameter reducing processing, the internal diameter of which is slightly smaller than the external diameter of an enlarged port section 1a of the battery case 1, from the bottom of the battery case 1 in order to reduce the diameter of the enlarged port section 1a of the battery case 1. When the foregoing battery case 1 is caulked, the caulked open end of the battery case 1 slightly presses down the electrode plate group 2 through the filter section 21 and the positive electrode collector 11. Therefore, the electrode plate group 2 is fixed in the battery case 1 so as not to move in the axial direction of the battery case 1. At this time, the insulating gasket 12 is deformed by receiving pressure from above from the caulked open end of the battery case 1, and hence the support bottom face 12b is pressed against the bottom face of the flange-shaped collar section 14 of the positive electrode collector 11. The negative electrode collector 27, on the other hand, receives a pressing force from the downwardly pressed electrode plate group 2, so that the elastic connecting section 27a is deformed. Therefore, variations in the height of each end portion 3a and 4a in the electrode plate group 2 are absorbed.

Since the diameter of the enlarged port section 1a of the battery case 1 is reduced, the filter section 21 of the port sealing member 8 and the positive electrode collector 11 are horizontally clamped with the insulating gasket 12, so that the port sealing member 8 is certainly fixed by extremely firm holding structure. Also, the electrode plate group 2 is fixed while being slightly compressed by, for example, approximately 0.2 mm in the axial direction of the battery case 1, so that the resistance to vibration and the resistance to impact of the battery are significantly improved.

After that, a predetermined amount of the electrolytic solution is injected into the battery case 1 from an injection nozzle 31 through the center of the cross-shaped opening 19 of the positive electrode collector 11.

Lastly, as shown by an arrow in FIG. 8A, the cap-shaped positive electrode terminal 22 of the port sealing member 8 is mounted on the filter section 21 with sandwiching the safety vent 23 between them, and then the filter section 21 and the cap-shaped positive electrode terminal 22 are connected by welding to assemble the port sealing member 8. In this manufacturing method, the insulating gasket 12 is fitted onto the flange-shaped collar section 14 of the positive electrode collector 11 and the periphery of the filter section 21 of the port sealing member 8, which are secured to each other by the welding, by pressing from above. Then, the end portion of the opening of the battery case 1 is caulked, and the diameter of the enlarged port section 1a is reduced to firmly fix the periphery of the filter section 21 and the flange-shaped collar section 14 of the positive electrode collector 11 by the battery case 1 with the insulating gasket 12. In this state, the electrolytic solution is injected through the vent 21a of the filter section 21 and the opening 19 of the positive electrode collector 11, and then the safety vent 23 and the cap-shaped positive electrode terminal 22 are attached to the filter section 21 to assemble the port sealing member 8. Therefore, because the workability of every assembling process is improved, the assembling processes are efficiently carried out, and hence it is possible to improve its productivity.

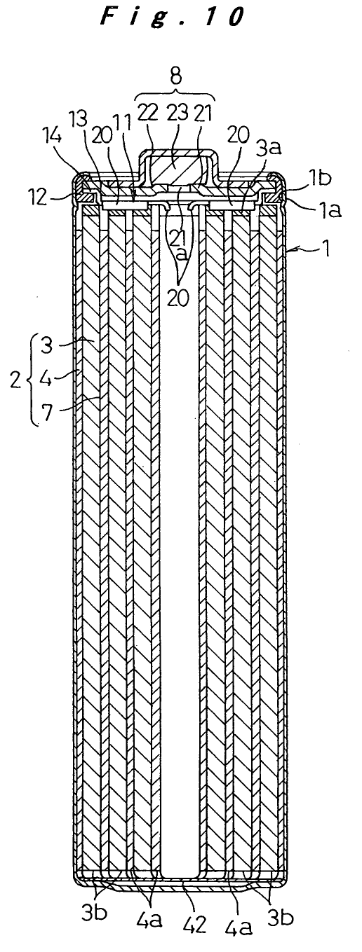

FIG. 10 is a longitudinal sectional view showing a battery according to a third embodiment of the present invention. In FIG. 10, the same numbers as FIG. 1 refer to identical or similar components, and duplicate description will be omitted. In this embodiment, the present invention is applied to a small battery such as an AA-size battery. The difference between the battery according to this embodiment and the battery according to the first embodiment is only the following structure. Namely, in an electrode plate group 2, a positive electrode plate 3 has such a width that one (lower, in the drawing) end portion 3b of the positive electrode plate 3 becomes coplanar to one end portion 4a of a negative electrode plate 4. A separator 7 protrudes from a lower end portion plane of the positive and negative electrode plates 3 and 4 of this electrode plate group 2. A relatively thin insulating plate 42 is disposed between the lower end portion of the electrode plate group 2 and the bottom face of the battery case 1, to insulate the electrode plate group 2 from the battery case 1. With this structure, the peripheral surface of the negative electrode plate 4, which forms the single most outward periphery of the electrode plate group 2, makes contact with the inner peripheral surface of the battery case 1, to connect the negative electrode plate 4 to the battery case 1.

In this battery, only the relatively thin insulating plate 42 is disposed between the electrode plate group 2 and the bottom face of the battery case 1, and the negative electrode collector 9 and the elastic conductive body 10 used in the first embodiment are omitted. Thus, it is possible to make effective use of the internal space of the battery case 1 for the small battery with small volume as a container for the electrode plate group 2, so that it is possible to obtain the small battery with high capacity due to increase in the volume of the electrode plate group 2. Furthermore, in this battery, the complicated welding process between the negative electrode collector 9 and the bottom face of the battery case 1 becomes unnecessary, because the negative electrode collector 9 is omitted especially. Therefore, there is an advantage that the simplification of the manufacturing process makes manufacture easy.

In addition to the foregoing effects, the foregoing battery can have the same effects as the first embodiment. In other words, the foregoing battery obtains high power output because the internal resistance of the battery is significantly reduced due to the elimination of the positive electrode lead, and has further high capacity because the volume of the electrode plate group 2 is increased due to the elimination of the ring-shaped groove. Reduction in the number of parts, attachment processes of the parts, and a forming process of the ring-shaped groove result in significant cost reduction. Furthermore, the periphery of a filter section 21 of a port sealing member 8 is horizontally clamped by an enlarged port section 1a with a reduced diameter in the battery case 1 with an insulating gasket 12 interposed therebetween, so that it is possible to obtain effects that the resistance to vibration and the resistance to impact of the battery are significantly improved.

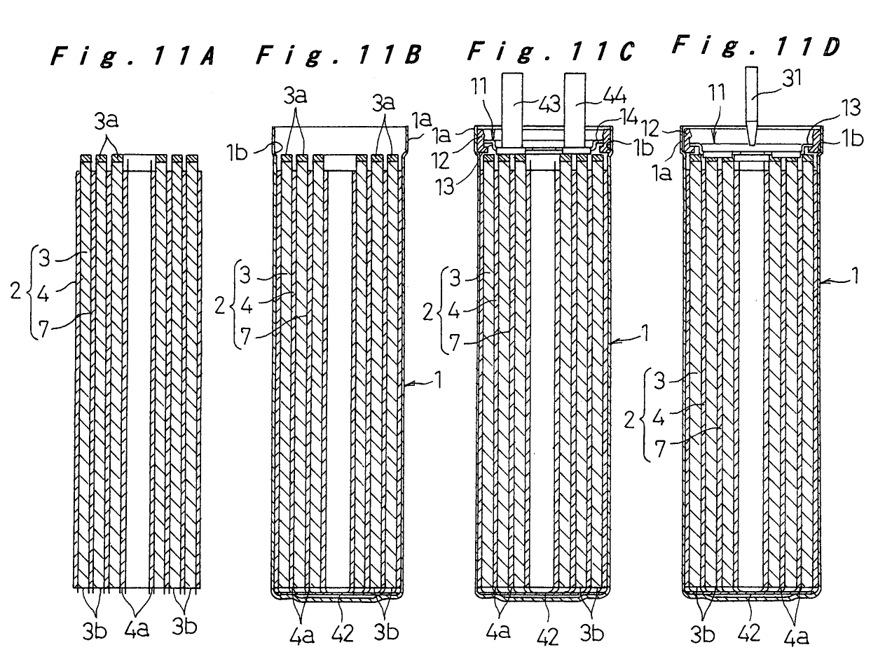

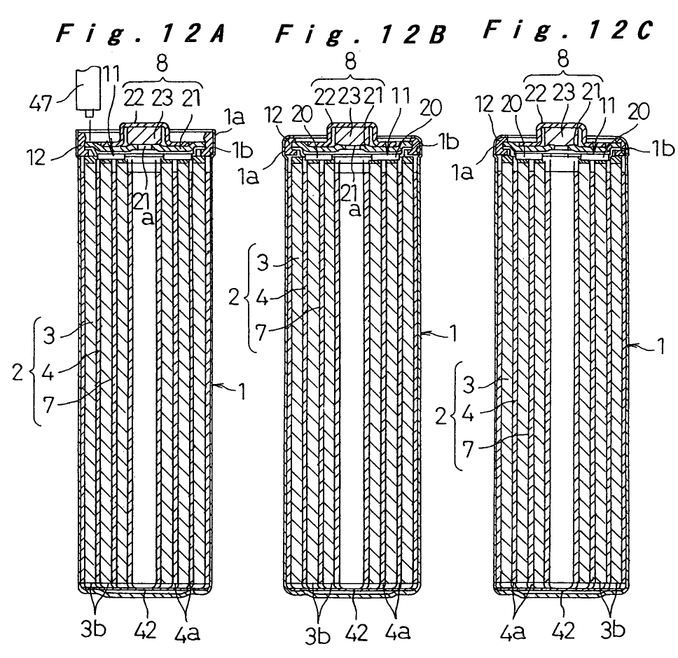

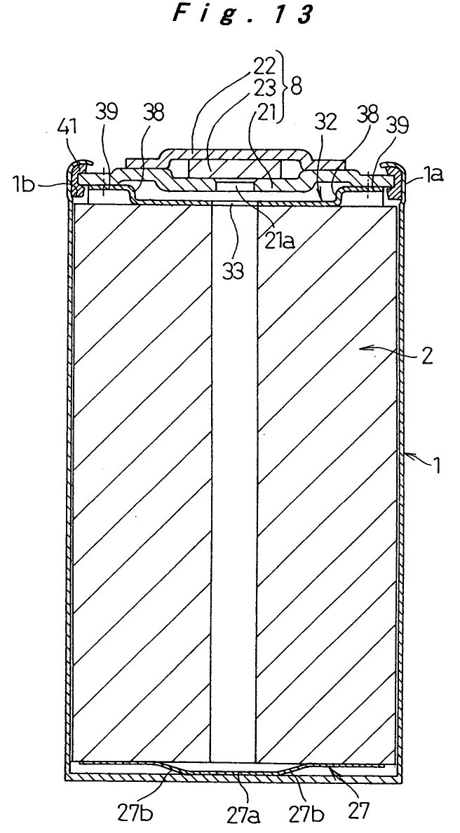

Next, a manufacturing process of the foregoing battery will be described with referring to FIGS. 11A to 12C. FIG. 11A shows the electrode plate group 2. In this electrode plate group 2, as described above, the positive electrode plate 3 is so formed as to have such a width that the one end portion 3b of the positive electrode plate 3 becomes coplanar to the one end portion 4a of the negative electrode plate 4. The separator 7 protrudes from the lower end portion plane of the positive and negative electrode plates 3 and 4 of the electrode plate group 2. This electrode plate group 2, as shown in FIG. 11B, is inserted into the battery case 1, after the insulating plate 42 inserted into the battery case 1 is put on the bottom face. Therefore, the lower end portion plane of the electrode plate group 2 is certainly insulated from the bottom face of the battery case 1 by a protruding section of the separator 7 and the insulating plate 42.

Then, as shown in FIG. 11C, a positive electrode collector 11, to the periphery of which the insulating gasket 12 is attached, is brought into contact with one end portion 3a of the positive electrode plate 3 of the electrode plate group 2, to carry out welding by use of a pair of welding electrodes 43 and 44. Furthermore, as shown in FIG. 11D, a certain amount of electrolytic solution is injected into the battery case 1 from an injection nozzle 31 through the center of a cross-shaped opening 19 of the positive electrode collector 11. Since the electrolytic solution is injected in a state that the port sealing member 8 is not attached, it is possible to easily carry out an injecting operation.

Then, as shown in FIG. 12A, the previously assembled port sealing member 8 which is inserted into the enlarged port section 1a of the battery case 1 is fitted into the insulating gasket 12. The periphery of the filter section 21 is overlaid on a flange-shaped collar section 14 of the positive electrode collector 11. In this state, the periphery of the filter section 21 of the port sealing member 8 and the positive electrode collector 11, which are overlaid to each other, are welded by laser welding with the use of a laser welding machine 47.

Then, as shown in FIG. 12B, the open end of the battery case 1 is inwardly caulked for preliminary sealing. After that, as shown in FIG. 12C, the battery case 1 is lastly pressed and inserted into a cylinder (not illustrated) for a diameter reducing processing, the internal diameter of which is slightly smaller than the external diameter of the enlarged port section 1a of the battery case 1, from the bottom of the battery case 1. Therefore, the diameter of the enlarged port section 1a of the battery case 1 is reduced, and the opening of the battery case 1 is formally sealed.

FIG. 13 is a sectional view showing a battery according to a fourth embodiment of the present invention. In FIG. 13, the same reference numbers as FIG. 1 refer to identical or similar components, and duplicate description will be omitted. The difference between the battery according to this embodiment and the battery according to the first embodiment is only the shapes of a positive electrode collector 32 and an insulating gasket 41.

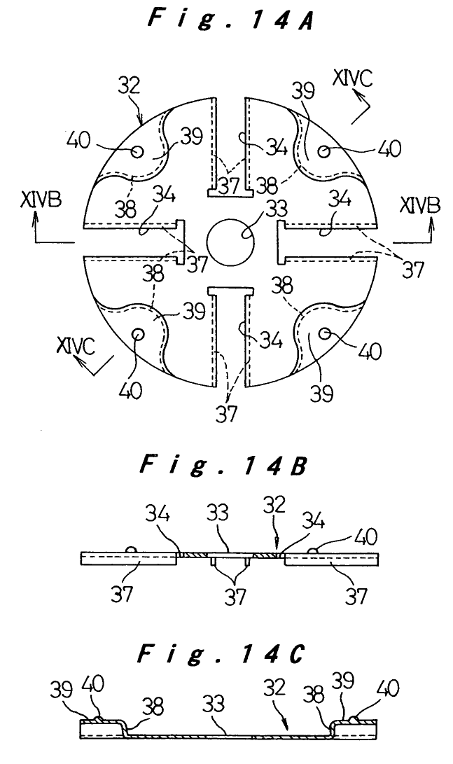

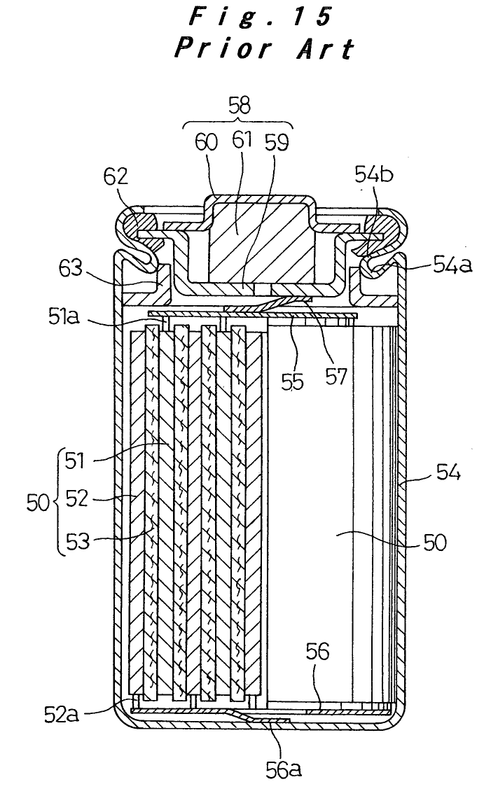

Namely, the positive electrode collector 32 has a shape as shown in FIGS. 14A to 14C. FIG. 14A is a plan view, FIG. 14B is a sectional view taken on a line XIVB-XIVB in FIG. 14A, and FIG. 14C is a sectional view taken on a line XIVC-XIVC in FIG. 14A. This positive electrode collector 32 is in the shape of a disk the external diameter of which is smaller than the external diameter of a filter section 21 of a port sealing member 8. A cylindrical injection hole 33 corresponding to an opening in the center of an electrode plate group 2 is formed in the center of the positive electrode collector 32. The positive electrode collector 32 has rectangular four cutouts 34, which extend from the vicinity of the injection hole 33 to four points positioned in its peripheral end portion at regular intervals of 90 degrees. Burring projecting pieces 37 which are orthogonally bent in a downward direction are integrally formed in the cutouts 34. Also, four welding rack sections 39, which are tiered with steps 38, are formed in the periphery of the positive electrode collector 32 at the midpoints of the cutouts 34, and each welding rack section 39 is provided with a projection 40 erect upwardly. An existing insulating gasket, which is generally used in a conventional battery, is used as the insulating gasket 41.

In this battery, the diameter of the positive electrode collector 32 is smaller than the diameter of the filter section 21 of the port sealing member 8, and the welding rack sections 39 which are tiered with the steps 38 are formed in the periphery of the positive electrode collector 32 with eliminating the flange-shaped collar section 14 provided in the first and second embodiments. Thus, each welding rack section 39 is connected to the bottom face in the vicinity of the periphery of the filter section 21 of the port sealing member 8 through the projections 40. Namely, this battery has as many connecting points as possible with eliminating the flange-shaped collar section 14.

Accordingly, in this battery, only the periphery of the filter section 21 of the port sealing member 8 is held by the enlarged port section 1a of the battery case 1 with the insulating gasket 41, so that it is possible to the approximately same effects as the first and second embodiments even if the existing insulating gasket is used as the insulating gasket 41. In other words, since the internal resistance of the battery is significantly reduced in this battery due to the elimination of the positive electrode lead, it is possible to obtain high power output. Since the elimination of the ring-shaped groove increases the volume of the electrode plate group 2, it is possible to increase the capacity of the battery. Reduction in the number of parts and the elimination of attachment processes of the parts and a forming process of the ring-shaped groove cause significant cost reduction. Furthermore, the periphery of the filter section 21 of the port sealing member 8 is horizontally clamped by the enlarged port section 1a with the reduced diameter in the battery case 1 with the insulating gasket 41 interposed therebetween, so that it is possible to obtain the effect of significantly improving the resistance to vibration and the resistance to impact.

In the battery according to the present invention, as described above, since the internal resistance of the battery is significantly reduced by the elimination of the positive electrode lead, it is possible to obtain the high power output. Also, since the volume of the electrode plate group is increased by the space which has conventionally occurred in the battery case due to the existence of the positive electrode lead and the ring-shaped groove, it is possible to increase the capacity of the battery. Therefore, the battery is appropriately applicable to an application as a driving power source for a cordless power tool, an electric vehicle, and the like which need a large load characteristic. Also, it is possible to manufacture the foregoing battery with high productivity by use of a manufacturing method of the battery according to the present invention.

Although the present invention has been fully described in connection with the preferred embodiments thereof, it is to be noted that various changes and modifications apparent to those skilled in the art are to be understood as included within the scope of the present invention as defined by the appended claims unless they depart therefrom.

1. A battery comprising a metal battery case in a shape of a cylinder with a bottom, an electrode plate group contained in the metal battery case, and a port sealing member, the electrode plate group including a strip-shaped positive electrode plate and a strip-shaped negative electrode plate which are spirally wound with a separator interposed therebetween, the port sealing member tightly sealing an opening in a top end of the battery case with an insulating gasket interposed therebetween, wherein
an enlarged port section is formed in the open end of the battery case above a top end of the electrode plate group, and a ring-shaped support rack section is provided inside of the enlarged port section; the battery has a collector of one pole in which a flange-shaped collar section tiered with a step is formed in the periphery of the collector, the bottom face of the collector inside of the flange-shaped collar section is connected to an end portion of the electrode plate of one pole protruding from the electrode plate group;
the periphery of the port sealing member, in which a filter section and a cap-shaped terminal section are integrated, is connected to the top face of the flange-shaped collar section;
the flange-shaped collar section of the collector is set on a support bottom face of the insulating gasket held on the support rack section; and
the open end of the battery is inwardly caulked, and the periphery of the port sealing member is fixed in the enlarged port section with a reduced diameter with the insulating gasket interposed therebetween.

2. The battery according to claim 1, wherein
the external diameter of the collector is the approximately same as the external diameter of the port sealing member, and the periphery of the port sealing member is set on the support bottom face of the insulating gasket while being overlaid on the flange-shaped collar section of the collector.

3. The battery according to claim 1, wherein
an opening is formed in the bottom face of the collector inside of the flange-shaped collar section, and a burring projecting piece bending in a downward direction is formed in the opening, and welding rack sections are formed so as to inwardly extend from a plurality of points of the flange-shaped collar section while keeping the same plane as the flange-shaped collar section, and each of the welding rack sections is welded to the bottom face of the periphery of the port sealing member.

4. The battery according to claim 1, wherein
a collector of the other pole is connected to an end portion of the electrode plate of the other pole protruding from the electrode plate group,
a ring-shaped elastic spacer is disposed between the collector of the other pole and the bottom face of the battery case, and
a tongue of the collector of the other pole is connected to the bottom face of the battery case through a space in the middle of the spacer.

5. The battery according to claim 4, wherein
a ring-shaped foamed metal is used as the spacer.

6. The battery according to claim 1, wherein
a collector of the other pole is connected to an end portion of the electrode plate of the other pole protruding from the electrode plate group, and
the collector of the other pole is formed in the shape of a disc spring having an elastic connecting section projecting downward in a middle section, and the elastic connecting section is connected to the bottom face of the battery case.

7. The battery according to claim 1, wherein
the insulating gasket made of a resin has the shape of a ring inwardly protruding from a bottom end, and the insulating gasket integrally has the support bottom face for supporting the periphery of the port sealing member and/or the collector of one pole, a tapered surface downwardly spreading an end face of the support bottom face, and a latching projection part provided above the support bottom face, the diameter of the latching projection part being slightly smaller than the external diameter of the port sealing member.

8. The battery according to claim 3, wherein
a projection is formed in each of the plurality of welding rack sections in the collector, and the port sealing member is connected to the welding rack sections by current-carrying welding through the medium of the projections and an electrolytic solution.

9. The battery according to claim 3, wherein
the periphery of the port sealing member is connected to the plurality of welding rack sections in the collector by laser welding.

10. The battery according to claim 1, wherein
the collector of one pole is connected to an end portion of the electrode plate of one pole protruding from one end face of the electrode plate group, end faces of both of the electrode plates are in the same plane in the other end face of the electrode plate group, the separator protrudes from the plane, an insulating plate is disposed between the other end face of the electrode plate group and the bottom face of the battery case, and the outer peripheral surface of the electrode plate of the other pole positioned in the outermost periphery of the electrode plate group makes contact with the inner peripheral surface of the battery case to establish electrical connection.

11. A battery comprising a metal battery case in a shape of a cylinder with a bottom, an electrode plate group contained in the metal battery case, and a port sealing member, the electrode plate group including a strip-shaped positive electrode plate and a strip-shaped negative electrode plate which are spirally wound with a separator interposed therebetween, the port sealing member tightly sealing an opening in a top end of the battery case with an insulating gasket interposed therebetween, wherein
an enlarged port section is formed in the open end of the battery case above a top end of the electrode plate group, and a ring-shaped support rack section is provided inside the enlarged port section;
the battery has a collector of one pole, in the periphery of which a welding rack section tiered with a step is formed, the bottom face of the collector inside of the welding rack section is connected to an end portion of the electrode plate of one pole protruding from the electrode plate group;
the periphery of the port sealing member, in which a filter section and a cap-shaped terminal section are integrated, is set on a support bottom face of the insulating gasket held on the support rack section, and the welding rack section of the collector of the one pole is connected to a part of the port sealing member inside of the periphery thereof; and
the open end is inwardly caulked, and the periphery of the port sealing member is fixed in the enlarged port section with a reduced diameter with the insulating gasket interposed therebetween.

12. A method for manufacturing a battery comprising the steps of:
connecting a bottom face of a positive electrode collector inside of a flange-shaped collar portion, which is formed in the periphery of the positive electrode collector while being tiered with a step, to an end portion of a positive electrode plate of an electrode plate group, and connecting a negative electrode collector to an end portion of a negative electrode plate of the electrode plate group;
attaching an insulating gasket onto the positive electrode collector before or after being connected to the end portion of the positive electrode plate;
inserting the electrode plate group into a battery case, to support the insulating gasket on a ring-shaped support rack section, which is formed inside of an enlarged port section formed above a top end of the electrode plate group in the battery case;
connecting the negative electrode collector to the bottom face of the battery case by welding;
injecting an electrolytic solution into the battery case through an opening formed in the positive electrode collector;
laminating and connecting a periphery of a port sealing member on a top face of the flange-shaped collar section of the positive electrode collector; and
inwardly caulking an open end of the battery and reducing a diameter of the enlarged port section to fix the periphery of the port sealing member and/or the flange-shaped collar section of the positive electrode collector with the insulating gasket interposed therebetween.

13. A method for manufacturing a battery comprising the steps of:
connecting a bottom face of a positive electrode collector inside of a flange-shaped collar portion, which is formed in a periphery of the positive electrode collector, to an end portion of a positive electrode plate of an electrode plate group, and connecting a negative electrode collector to an end portion of a negative electrode plate of the electrode plate group;
laminating and welding a periphery of a filter section of a port sealing member to a top face of the flange-shaped collar portion of the positive electrode collector for connection;
attaching an insulating gasket onto the periphery of each of the positive electrode collector and the filter section from above;
inserting the electrode plate group into a battery case to support the insulating gasket on a ring-shaped support rack section, which is formed inside of an enlarged port section formed above a top end of the electrode plate group in the battery case;
connecting the negative electrode collector to the bottom face of the battery case by welding;
injecting an electrolytic solution into the battery case through a vent of the filter section and an opening of the positive electrode collector;
connecting the filter section and a cap-shaped positive electrode terminal to each other by welding in a state that the positive electrode terminal is laminated on the filter section with a safety vent interposed therebetween to assemble the port sealing member; and
inwardly caulking an open end of the battery case, and reducing a diameter of the enlarged port section to fix the periphery of the filter section and/or the flange-shaped collar section of the positive electrode collector with the insulating gasket interposed therebetween.

14. The battery according to claim 2, wherein
the collector of one pole is connected to an end portion of the electrode plate of one pole protruding from one end face of the electrode plate group, end faces of both of the electrode plates are in the same plane in the other end face of the electrode plate group, the separator protrudes from the plane, an insulating plate is disposed between the other end face of the electrode plate group and the bottom face of the battery case, and the outer peripheral surface of the electrode plate of the other pole positioned in the outermost periphery of the electrode plate group makes contact with the inner peripheral surface of the battery case to establish electrical connection.

15. The battery according to claim 3, wherein
the collector of one pole is connected to an end portion of the electrode plate of one pole protruding from one end face of the electrode plate group, end faces of both of the electrode plates are in the same plane in the other end face of the electrode plate group, the separator protrudes from the plane, an insulating plate is disposed between the other end face of the electrode plate group and the bottom face of the battery case, and the outer peripheral surface of the electrode plate of the other pole positioned in the outermost periphery of the electrode plate group makes contact with the inner peripheral surface of the battery case to establish electrical connection.

16. The battery according to claim 7, wherein
the collector of one pole is connected to an end portion of the electrode plate of one pole protruding from one end face of the electrode plate group, end faces of both of the electrode plates are in the same plane in the other end face of the electrode plate group, the separator protrudes from the plane, an insulating plate is disposed between the other end face of the electrode plate group and the bottom face of the battery case, and the outer peripheral surface of the electrode plate of the other pole positioned in the outermost periphery of the electrode plate group makes contact with the inner peripheral surface of the battery case to establish electrical connection.

17. The battery according to claim 8, wherein
the collector of one pole is connected to an end portion of the electrode plate of one pole protruding from one end face of the electrode plate group, end faces of both of the electrode plates are in the same plane in the other end face of the electrode plate group, the separator protrudes from the plane, an insulating plate is disposed between the other end face of the electrode plate group and the bottom face of the battery case, and the outer peripheral surface of the electrode plate of the other pole positioned in the outermost periphery of the electrode plate group makes contact with the inner peripheral surface of the battery case to establish electrical connection.

18. The battery according to claim 9, wherein
the collector of one pole is connected to an end portion of the electrode plate of one pole protruding from one end face of the electrode plate group, end faces of both of the electrode plates are in the same plane in the other end face of the electrode plate group, the separator protrudes from the plane, an insulating plate is disposed between the other end face of the electrode plate group and the bottom face of the battery case, and the outer peripheral surface of the electrode plate of the other pole positioned in the outermost periphery of the electrode plate group makes contact with the inner peripheral surface of the battery case to establish electrical connection.
